(19) United States
(12) Patent Application Publication
(10) Pub. No.: US 2010/0307622 A1
(43) Pub. Date: Dec. 9, 2010

(54) PIPE HAVING FUNCTION CAPABLE OF PREVENTING FREEZING BURST USING STRIP TYPE SURFACE HEATER AND FABRICATING METHOD THEREOF

(75) Inventors: Jae Yeong Lee, Seoul (KR); Hyun Chul Lim, Gwangmyeong-si (KR); Sung Chul Yang, Seoul (KR); Sang Dong Jeong, Gimpo-si (KR); Soung Ho Jang, Gimpo-si (KR)

Correspondence Address: CANTOR COLBURN LLP, 20 Church Street, 22nd Floor, Hartford, CT, 06103, US

(73) Assignee: AMOGREENTECH CO., LTD., Kimpo-si (KR)

(21) Appl. No.: 12/747,994

(22) PCT Filed: Dec. 4, 2008
(86) PCT No.: PCT/KR2008/007149

§ 371 Date: Jul. 29, 2010

(30) Foreign Application Priority Data
Dec. 14, 2007 (KR) 10-2007-0131362

(51) Int. Cl. F16L 53/00; B32B 37/16

(52) U.S. Cl. 138/33; 156/274.2

(57) ABSTRACT

Provided is a pipe having an anti-freezing function including a strip type surface heating element which is capable of having a function of preventing the pipe from freezing and bursting, and a fabricating method thereof, in which the pipe is a relatively thin film and includes a surface heating element therein. The anti-freezing pipe includes: a ribbon heater which has a strip type surface heating element which emits heat when electric power is applied to both ends of at least one strip, and the strips are arranged with an interval in parallel with each other when the strip type surface heating element is formed with a number of strips, and an insulation layer which is coated on the outer circumference of the strip type surface heating element in a plate form, and which is spirally wound to form a cylindrical shape; and a spiral junction portion which pins side surfaces of the spirally wound ribbon heater.

### TECHNICAL FIELD

The present invention relates to a pipe having a function capable of preventing freezing burst using a strip type surface heating element and a fabricating method thereof, and more particularly to, a pipe having an anti-freezing function including a strip type surface heating element which is capable of having a function of preventing the pipe from freezing and bursting, and a fabricating method thereof, in which the surface heating element including at least one strip is coated with an insulation film, to thus fabricate a ribbon heater, and then the ribbon heater is molded into a tubular form, that is, the pipe whose thickness is a relatively thin film and which includes the surface heating element therein.

### BACKGROUND ART

In general, since water pipes which are installed at homes, office buildings, or factories, or pipes which transfer various kinds of solutions at factories are inevitably exposed to the outside, in particular, in the air, they may be frozen to burst unless they have heating facilities, respectively.

In high-volume mass production systems of recent frontier industries, temperature, flux or quantity of flow, pressure, level, etc., should be controlled precisely and quickly because they decisively influence upon productivity, quality, etc. Accordingly, a flux transmitter and a pressure transmitter are the most important fields in a manufacturing process. Here, it should be measured along all lines of pipes whether how much flux has flown in the respective pipes or how much pressure has occurred therein. The flux transmitter and the pressure transmitter receive analog signals resulting from the measured fluxes and pressures, in a differential pressure form, and send the received analog signals to a controller to thus control valves.

For this, a heater cable is attached to and installed in an induced pressure pipe line through which flux and pressure of liquid are detected. Then, electricity is supplied through the heater cable, to thus maintain the induced pressure pipe line at 30° C. to 50° C. By doing so, it is required that the induced pressure pipe line should be anti-frozen and accurate flux and pressure should be detected.

According to the conventional art, water pipes which are installed at homes, office buildings, or factories, or pipes which transfer various kinds of solutions at factories, employ a method of winding an anti-freezing heater around the outer circumference of the respective pipes, or a method of having the respective pipes contain an anti-freezing heater, in order to prevent the pipes from being frozen to burst.

Korean Utility-model Registration No. 219527 using a nichrome wire as a heat generating wire, Korean Utility-model Registration No. 293218 where a thin nichrome wire is wound as a bundle of a fiber, and Korean Utility-model Registration No. 137043 which discloses a polymer heater whose temperature is self-regulated, have been known as the anti-freezing heaters. These anti-freezing heaters are formed of a cord shape whose thickness is about 2-3 mm and whose width is about 10 mm, respectively. As a result, since the anti-freezing heaters are thick and are of a low flexibility, cohesiveness and workability drop when they are wound around the pipes. Accordingly, a heat transfer efficiency which means that heat generated from the heat wires is transmitted to the pipes is low and a cost for manufacturing the anti-freezing heaters is high.

Meanwhile, in the case of an electric heater heat insulation pipe structure disclosed in Korean Utility-model Registration No. 367343, as a pipe which contains a heater and has an anti-freezing function, a carbon heat generating wire which is formed by coating carbon and silicon around the outer circumference of a fiber yarn is fabricated in a net form of a predetermined width and length, together with an auxiliary wire made of a fiber yarn, and then a carbon heater which is formed by coating the carbon heat generating wire using an insulating material of silicon, etc., is wound around the outer circumference of the pipe, in which the outer circumference of the carbon heater is surrounded by a thermal insulating material.

That is, since the heat insulation pipe is formed so that the carbon heat generating wire which is formed by coating carbon and silicon around the outer circumference of a fiber yarn is fabricated in a net form of a predetermined width and length, together with an auxiliary wire, so as to have the carbon heater having a constant area in the form of a ribbon, and then the carbon heater is coated with the insulating material, a manufacturing process becomes complicated and a manufacturing cost rises up.

In addition, Korean Utility-model Publication No. 1999-41828 discloses an anti-freezing heating pipe in which a pair of conductors are disposed and spaced from each other by a predetermined interval at the left and right sides, and a heating cable which is formed by coating carbon and heat-resistant resin such as polyethylene in turn is symmetrically buried in the lengthy direction on a main wall surface of a pipe made of soft resin.

In the case of the anti-freezing heating pipe, a caloric value of the heating cable is automatically controlled according to ambient temperature, but a manufacturing cost rises up.

Thus, since most of the conventional anti-freezing heating pipes use a heater made of a nichrome wire or thermal wire material having a circular cross-section, an insulating layer should be essentially formed in order to coat the heater. Accordingly, the conventional anti-freezing heating pipes become relatively thick. As a result, in the case of the conventional anti-freezing heating pipes, a heat transfer efficiency is low and a manufacturing cost is high.

### DISCLOSURE OF INVENTION

### Technical Problem

To solve the above problems, it is an object of the present invention to provide a pipe having an anti-freezing function including a strip type surface heating element which is capable of having a function of preventing the pipe from freezing and bursting, and a fabricating method thereof, in which the surface heating element including at least one strip is coated with an insulation film, to thus fabricate a ribbon heater, and then the ribbon heater is molded into a tubular form, that is, the pipe whose thickness is a relatively thin film and which includes the surface heating element therein.

It is another object of the present invention to provide a pipe having an anti-freezing function and a fabricating method thereof, which uses a strip type surface heating element which can be inexpensively fabricated by a sequential production method by using a Fe-based inexpensive metallic material instead of using an expensive metallic material such as Ni as a ribbon heater, to thus manufacture the anti-freezing pipe inexpensively.

It is still another object of the present invention to provide a pipe having an anti-freezing function and a fabricating method thereof, in which a heater is embodied in a thin film strip type surface-shaped form, to thus widen a contact area where the heater contacts fluid in the pipe, and to thereby heighten a heat transfer efficiency and reduce electric power consumption.

It is yet another object of the present invention to provide a pipe having an anti-freezing function and a fabricating method thereof, which is incorporated with a strip type surface heating element which can be inexpensively fabricated by a sequential production method by using a Fe-based amorphous material.

### Technical Solution

To accomplish the above objects of the present invention, according to an aspect of the present invention, there is provided a pipe having an anti-freezing function, the anti-freezing pipe comprising:

a ribbon heater which has a strip type surface heating element which emits heat when electric power is applied to both ends of at least one strip, and the strips are arranged with an interval in parallel with each other when the strip type surface heating element is formed with a number of strips, and an insulation layer which is coated on the outer circumference of the strip type surface heating element in a plate form, and which is spirally wound to form a cylindrical shape; and

a spiral junction portion which joins side surfaces of the spirally wound ribbon heater.

According to another aspect of the present invention, there is provided a pipe having an anti-freezing function, the anti-freezing pipe comprising:

a cylindrical pipe;

a ribbon heater which has a strip type surface heating element which emits heat when electric power is applied to both ends of at least one strip, and the strips are arranged with an interval in parallel with each other when the strip type surface heating element is formed with a number of strips, and an insulation layer which is coated on the outer circumference of the strip type surface heating element in a plate form, and which is spirally wound to form a cylindrical shape; and

a protective layer which is formed on the outer side of the ribbon heater to protect the spirally wound ribbon heater.

Preferably but not necessarily, the spiral junction portion is formed by a butt joint method at a state where the side surfaces of the spirally wound ribbon heater face each other, or by an overlap joint method at a state where the side surfaces of the spirally wound ribbon heater overlap each other.

Preferably but not necessarily, the ribbon heater which is spirally wound on the outer circumference of the pipe can be wound in a butt joint form or an overlap joint form between the side surfaces of the spirally wound ribbon heater.

Preferably but not necessarily, the strip type surface heating element is made of an amorphous strip or FeCrAl.

More preferably but not necessarily, the amorphous strip can be made of a Fe-based alloy material.

Preferably but not necessarily, the insulation can be made of synthetic resin or silicon.

Preferably but not necessarily, the strips are joined by any one of a series connection, a parallel connection and a combination of series and parallel connections.

Preferably but not necessarily, an electric current interruption unit which operates within a predetermined range of temperature is further installed on the strip.

According to still another aspect of the present invention, there is also provided a method of manufacturing a pipe having an anti-freezing function, the anti-freezing pipe manufacturing method comprising the steps of:

overlapping an insulation film on the respective upper and lower sides of a strip type surface heating element which emits heat when electric power is applied to both ends of at least one strip, and the strips are arranged with an interval in parallel with each other when the strip type surface heating element is formed with a number of strips, to thereby fabricate a ribbon heater in which an insulation layer is formed on the outer circumference of the strip type surface heating element in a plate shape; and

winding the ribbon heater spirally so as to form a cylindrical shape to simultaneously join the side surfaces of the spirally wound ribbon heater.

According to yet still another aspect of the present invention, there is also provided a method of manufacturing a pipe having an anti-freezing function, the anti-freezing pipe manufacturing method comprising the steps of:

overlapping an insulation film on the respective upper and lower sides of a strip type surface heating element which emits heat when electric power is applied to both ends of at least one strip, and the strips are arranged with an interval in parallel with each other when the strip type surface heating element is formed with a number of strips, to thereby fabricate a ribbon heater in which an insulation layer is formed on the outer circumference of the strip type surface heating element in a plate shape; and

winding the ribbon heater spirally on the outer circumference of the pipe to simultaneously insert-extrude a protective layer on the outer side of the ribbon heater to protect the spirally wound ribbon heater.

### ADVANTAGEOUS EFFECTS

Therefore, the present invention provides a pipe having an anti-freezing function including a strip type surface heating element which is capable of having a function of preventing the pipe from freezing and bursting, and a fabricating method thereof, in which the surface heating element including at least one strip is coated with an insulation film, to thus fabricate a ribbon heater, and then the ribbon heater is molded into a tubular form, that is, the pipe whose thickness is a relatively thin film and which includes the surface heating element therein. Thus, the surface heating element widens a contact area where the heater contacts fluid in the pipe, and heat is transferred through a thin film insulation layer, to thereby heighten a heat transfer efficiency of the heater and reduce electric power consumption thereof.

In addition, the present invention provides a pipe having an anti-freezing function and a fabricating method thereof, which uses a ribbon heater which can be inexpensively fabricated by a sequential production method by using a Fe-based inexpensive metallic material instead of using an expensive metallic material such as Ni, to thus manufacture the anti-freezing pipe inexpensively.

### BRIEF DESCRIPTION OF DRAWINGS

FIG. 1 is a partially cutoff plan view illustrating a ribbon heater using a strip type surface heating element which is employed to manufacture a pipe having an anti-freezing function according to the present invention.

FIG. 2 is a cross-sectional view illustrating a method of manufacturing a ribbon heater using the strip type surface heating element illustrated in FIG. 1.

FIGS. 3 and 4 are partially cutoff perspective views respectively illustrating the anti-freezing pipe which has been manufactured using the ribbon heater which is shown in FIGS. 1 and 2, in which both electric power terminals are disposed at one side of the ribbon heater as an example, and both the electric power terminals are disposed at one side and the other side of the ribbon heater as another example.

FIG. 5 is a cross-sectional view lengthily illustrating the anti-freezing pipe which is manufactured by joining side surfaces of the ribbon heater according to a first embodiment of the present invention, using a butt joint method.

FIG. 6 is a cross-sectional view lengthily illustrating the anti-freezing pipe which is manufactured by joining side surfaces of the ribbon heater according to a second embodiment of the present invention, using an overlap joint method.

FIG. 7 is a cross-sectional view lengthily illustrating the anti-freezing pipe which is manufactured by winding the ribbon heater according to a third embodiment of the present invention on the outer circumference of a previously fabricated pipe and then forming a protective layer by an insert-extrusion method.

### BEST MODE FOR CARRYING OUT THE INVENTION

The above and/or other objects and/or advantages of the present invention will become more apparent by the following description.

Hereinbelow, an anti-freezing pipe according to respective embodiments of the present invention will be described with reference to the accompanying drawings in detail.

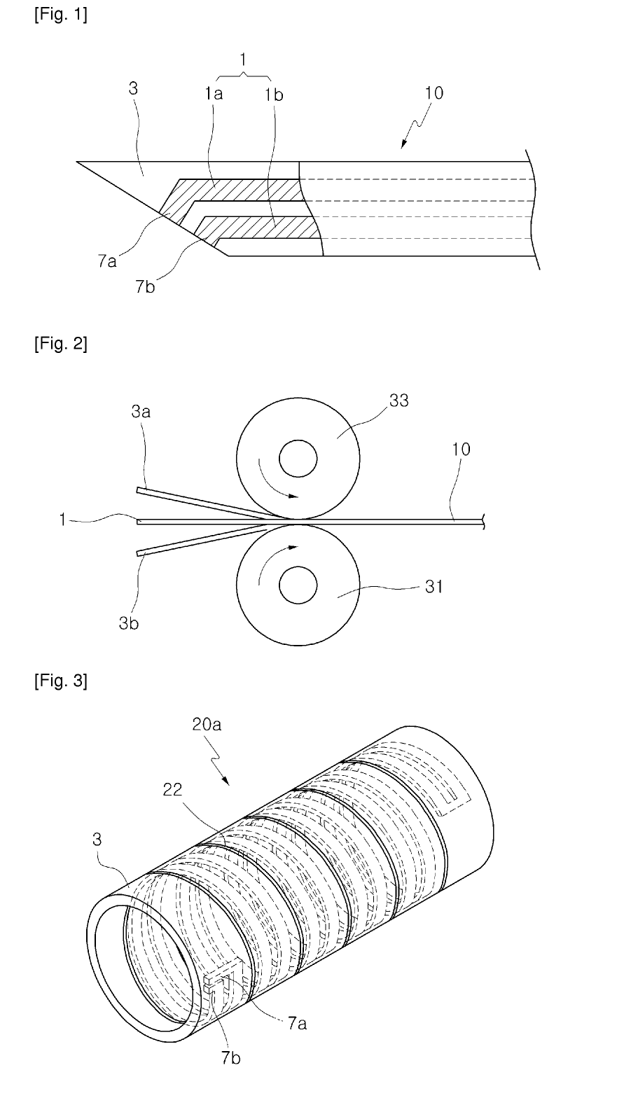

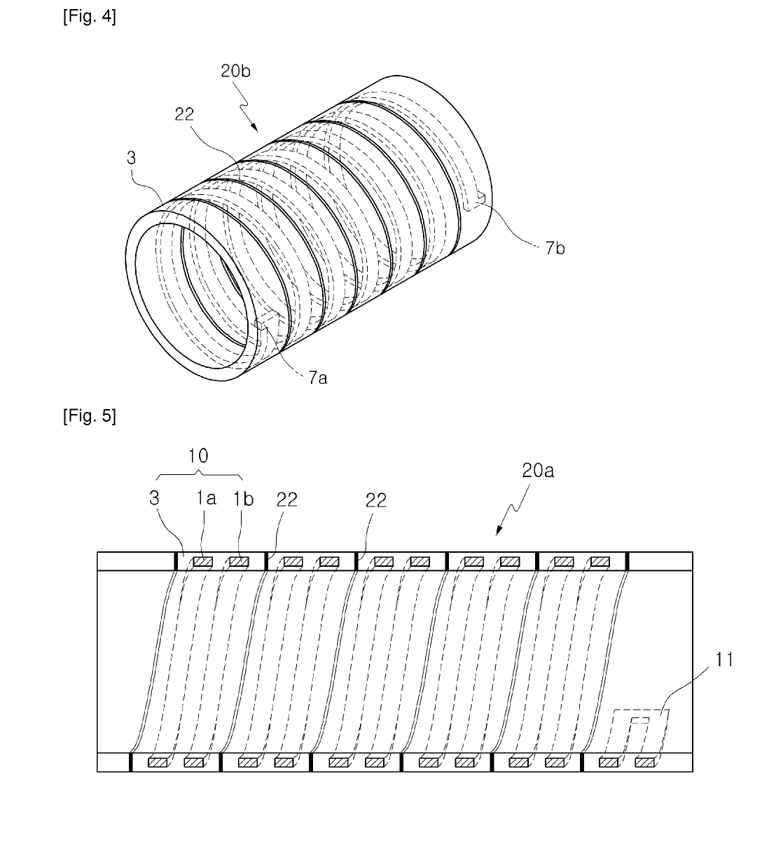

FIG. 1 illustrates a ribbon heater using a strip type surface heating element which is employed to manufacture a pipe having an anti-freezing function according to the present invention. FIG. 2 illustrates a method of manufacturing a ribbon heater using a strip type surface heating element illustrated in FIG. 1. FIGS. 3 and 4 illustrate the anti-freezing pipe which has been manufactured using the ribbon heater which is shown in FIGS. 1 and 2, respectively, in which both electric power terminals are disposed at one side of the ribbon heater as an example, and both the electric power terminals are disposed at one side and the other side of the ribbon heater as another example.

The anti-freezing pipe according to an embodiment of the present invention is manufactured by using a ribbon heater shown in FIGS. 1 and 2, respectively.

Referring to FIG. 1, a ribbon heater 10 using a strip type surface heating element which is employed to manufacture a pipe having an anti-freezing function according to the present invention, includes: a strip type surface heating element 1 which emits heat when electric power is applied to both ends of at least one strip, and a number of strips 1a and 1b are arranged with an interval in parallel with each other when the strip type surface heating element 1 is formed with a number of the strips 1a and 1b, in which both side ends of the respective adjacent strips are connected mutually in a series or parallel connection method; and an insulation layer 3 which is coated on the outer circumference of the strip type surface heating element 1 in a ribbon shape.

As shown in FIGS. 1 and 3, the strip type surface heating element 1 may be configured to have two strips 1a and 1b which are connected in series, in which both first and second electric power terminals 7a and 7b are disposed at one side of the strip type surface heating element 1. Otherwise, as shown in FIG. 4, the strip type surface heating element 1 may be configured to have one strip 1a in which both first and second electric power terminals 7a and 7b are disposed at one side and the other side of the strip type surface heating element 1, respectively.

In the case that both first and second electric power terminals 7a and 7b are disposed at one side and the other side of the strip type surface heating element 1, the strip type surface heating element 1 may be configured by connecting an even number of strips using a series connection method. Meanwhile, in the case that both first and second electric power terminals 7a and 7b are disposed at one side and the other side of the strip type surface heating element 1, respectively, the strip type surface heating element 1 may be configured by connecting an odd number of strips using a series connection method.

In the case of the ribbon heater 10 according to the present invention, the first and second electric power terminals 7a and 7b whose one end is respectively connected to a plug by an electric power cable, are spot-welded to the strip type surface heating element 1 and thereafter are coated to seal the welded portions using an insulation film. Otherwise, it is possible to insert a fuse in any one place between the first and second electric power terminals 7a and 7b and between the strips 1a and 1b, so that electric interruption can occur when an electric power supply circuit becomes electrically shorted and thus overcurrent flows in the electric power supply circuit.

In addition, in the case of the ribbon heater 10, a bimetal is installed in series in the middle of the strips 1a and 1b, or in any one place between the first and second electric power terminals 7a and 7b and between the strips 1a and 1b, so that electric power applied to the first and second electric power terminals 7a and 7b is automatically interrupted when ambient temperature rises up above preset temperature, and electric power is automatically applied to the first and second electric power terminals 7a and 7b when ambient temperature falls down below preset temperature.

As described above, in the case that an electric current interruption unit such as a bimetal or fuse is provided at one of the first and second electric power terminals 7a and 7b and between the strips 1a and 1b, electric power is applied to the heater 1 only within preset temperature or the electric current interruption unit such as the fuse or bimetal cuts off the electric power for the heater 1 when overcurrent flows in the electric power supply circuit, to accordingly prevent fire outbreak.

The ribbon heater 10 which is illustrated in FIG. 1 uses a slitting pattern formation method. For example, a ribbon formed of a thin film metallic material is slitted into a pattern of a number of strips 1a and 1b having a width of 0.5-200 mm so as to have a predetermined resistance value. Accordingly, the width of the ribbon is narrowed, and the overall length of the heater is lengthened due to a series connection structure. As a result, the strip type surface heating element 1 is fabricated in which two electric power terminals are disposed at one side or both sides of the strip type surface heating element 1. Thereafter, the outer portion of the surface heating element 1 is lengthily coated using a pair of insulation films, to thus form an insulation layer 3.

The strip type surface heating element 1 consists of any one selected from the group containing a single element metal thin plate of Fe, Al, Cu, etc., an iron-based (Fe—X) or iron chrome based (Fe—Cr) metal thin plate, a FeCrAl alloy thin plate such as Fe-(14-21%)Cr-(2-10%)Al, a nichrome heat wire made of Ni (77% or more), Cr (19-21%) and Si (0.75-1.5%) or Ni (57% or more), Cr (15-18%), Si (0.75-1.5%), and Fe (remaining part), and an amorphous thin plate (ribbon).

Preferably, a Fecalloy alloy (product name; KANTHAL™) mixed at a ratio of Fe-15Cr-5Al or Fe-20Cr-5Al-REM (rare earth metal) (here, including REM (Y, Hf, Zr) of 1% or so) can be used as an alloy material of the FeCrAl alloy thin plate.

In addition, the amorphous thin plate is made of a Fe-based or Co-based amorphous alloy material. Since the Fe-based amorphous alloy material is relatively inexpensive, the Fe-based amorphous alloy material is more preferable than the Co-based amorphous alloy material.

The Fe-based amorphous alloy material is, for example, Fe_{100-u-y-z-w}RᵤTₓQ_{y}B_{z}Si_{w}. Here, R includes at least one selected from the group containing Ni and Co, T includes at least one selected from the group containing Ti, Zr, Hf, V, Nb, Ta, Mo and W, Q includes at least one selected from the group containing Cu, Ag, Au, Pd and Pt, u is a value within a range of 0-10, x is a value within a range of 1-5, y is a value within a range of 0-3, and z is a value within a range of 5-12, and w is a value within a range of 8-18.

The Co based amorphous alloy material is, for example, Co₁₋ₓ₁₋ₓ₂Feₓ₁Mₓ₂)ₓ₃Bₓ₄. Here, M includes at least one selected from the group containing Cr, Ni, Mo and Mn, and x1, x2, and x3 have a value within a range of 0≦x1≦0.10, 0≦x2≦0.10, and 70≦x3≦79, respectively. In an amorphous alloy having the above-defined composition, x4 which is a composition ratio of B has a value within a range of 11.0≦x1≦13.0.

The most desirable material among the materials of the strip type surface heating element 1 is a Fe-15Cr-5Al or Fe-based amorphous alloy material. In the case that the Fe-15Cr-5Al amorphous alloy material is thermally treated, an Al₂O₃ (alumina) oxide insulation film is formed on the surface of the strip type surface heating element 1. Accordingly, the strip type surface heating element 1 made of the Fe-15Cr-5Al amorphous alloy material has a high temperature corrosion-resistant property to thus solve an oxidation problem of the Fe-based material inexpensively.

In addition, the specific resistance of NIKROTHAL™ (Ni: 80) which is a nichrome (NiCr) heat wire among the well-known high temperature heat wire materials is known as 1.09 Ωmm²/m, and the specific resistance of KANTHAL™ D is known as 1.35 Ωmm²/m. By the way, since the specific resistance of the Fe-based amorphous thin plate (ribbon) is 1.3-1.4 Ωmm²/m similar to that of the KANTHAL™ heat wire, it can be seen that the Fe-based amorphous thin plate (ribbon) has an excellent characteristic as a heat wire material. Further, since the Fe-based amorphous thin plate (ribbon) is relatively inexpensive in comparison with the KANTHAL™ heat wire, the Fe-based amorphous thin plate (ribbon) is used as a material of the strip type surface heating element 1, in the present invention.

However, any metal or alloy materials may be used as the material of the strip type surface heating element 1, if they have a specific resistance value which is required as a heat wire property and are inexpensively available in the market, respectively.

Meanwhile, the amorphous thin plate (ribbon) is obtained by spraying a molten alloy of an amorphous alloy into a high speed rotating cooling roll by a liquid quenching technique, for example, and cooling and peeling the same at a cooling rate of 10⁶K/sec, and is made into 10-50 μm thick and 0.5-200 mm wide. In addition, the amorphous alloy material has excellent material properties of high strength, high corrosion-resistance, high soft magnetism, etc., and the Fe-based amorphous ribbon can be purchased inexpensively at about half a cost when compared with a conventional silicon heater or nichrome wire heater. In addition, the Fe-based amorphous ribbon is directly obtained into a thin plate of 10-50 μm without passing through a multi-stage rolling process which makes a slab into a thin film when compared with the FeCrAl alloy thin plate. Accordingly, the Fe-based amorphous ribbon is the most inexpensive.

As described above, the amorphous thin plate (ribbon) is obtained into an amorphous thin plate of 10-50 μm, and thus has a surface area more than 10-20 times when compared with other coil type heat wires having the same surface area as that of the amorphous thin plate (ribbon). Accordingly, when the amorphous thin plate (ribbon) emits heat using identical electric power, heat is emitted at low temperature over a wide area. As a result, the amorphous thin plate (ribbon) is suitable for a low temperature heating material. That is, because the amorphous ribbon is formed of a thin plate, a thermal density that represents heat which is emitted per 1 cm² is low, and an amount of calorie is low. Therefore, the strip type surface heating element 1 that is produced by processing the amorphous ribbon made of the thin plate in this invention does not need to form a thick heat-resistant coating layer on the outer circumference of the heater, as the insulation layer 3, considering relatively excess and/or high temperature heat emission, when compared with the conventional coil type heat wires.

In addition, when the ribbon heater 10 that is manufactured using the strip type surface heating element 1 which is applied in the present invention is manufactured into an anti-freezing pipe as shown in FIGS. 3 and 4, the anti-freezing pipe contacts the internal fluid flowing in the anti-freezing pipe over a wide contacting area, and does not need to form a thick coating layer. Accordingly, a heat transfer efficiency from the surface heating element 1 to the anti-freezing pipe becomes high.

In addition, synthetic resin having excellent heat resistance and electric insulation properties can be used as a material of the insulation layer 3 which is coated on the outer surface of the strip type surface heating element 1 to perform a moisture-proof, heat-resistance and electric insulation function. For example, various electric insulation film materials such as PE (Polyethylene), PP (Polypropylene), PET (Polyethylene Terephthalate) which is obtained by polymerizing TPA (Terephthalic Acid) and MEG (Mono-ethylene Glycol), polyimide or silicon, can be used as the materials for the insulation layer.

The synthetic resin which is used as the material of the insulation layer 3 is usually relatively inexpensive and has excellent electric insulation, thermal stability, water-resistance properties. The silicon has also excellent heat resistance, tensile strength, expansion and contraction capability and abrasion-resistance properties.

Meanwhile, for example, in this invention, the ribbon of a broad width is slitted into strips 1a and 1b having a width of 0.5-200 mm, or the broader width than the width of 0.5-200 mm as being the case, in order to have a resistance value which is suitable when the ribbon has a predetermined length such as 1 m, 2 m, and 5 m and emits heat at a predetermined temperature. By doing so, it is desirable that the width of the heater becomes narrow and the overall length thereof becomes long.

Hereinbelow, a method of manufacturing a ribbon heater using the strip type surface heating element according to this invention will be described.

FIG. 2 is a cross-sectional view illustrating a method of manufacturing a ribbon heater using the strip type surface heating element illustrated in FIG. 1.

The ribbon heater can be fabricated using two silicon rolls 31 and 33 which have an equal diameter each other and containing a heater, respectively. That is, synthetic resin films 3a and 3b which are available as an insulation material 3 are overlapped on the upper and lower sides of the strip type surface heating element 1, respectively. For example, synthetic resin films 3a and 3b which are available as an insulation material 3 which are respectively overlapped on the upper and lower sides of the strip type surface heating element 1, are made to pass through the silicon rolls 31 and 33 which are set up at 100-200° C., perpendicularly with the axes of the rolls 31 and 33, to thus obtain a ribbon heater 10.

The ribbon heater 10 that uses the strip type surface heating element 1 can be generally formed into a thin film of 0.2-5 mm thick and 10-200 mm wide or larger, according to a unit length.

In addition, in the case that the ribbon heater 10 is formed of a pipe, it is desirable that the pipe is fabricated into the thickness of at least 0.2 mm or larger so that the pipe can endure an internal fluid pressure in the pipe. The thickness of the heater is determined considering a fluid pressure in the pipe. In this case, it is desirable that the strips 1a and 1b are processed into a number of waves so as to absorb pressures of the fluid flowing in the pipe and contract/expand.

Moreover, the ribbon heater 10 according to this invention can be usefully applied in manufacturing a pipe whose diameter is big and whose length is long, because it can be fabricated into a broad width of 50-200 mm.

Hereinbelow, a method of manufacturing an anti-freezing pipe that uses the ribbon heater according to this invention will be described.

FIG. 5 is a cross-sectional view lengthily illustrating the anti-freezing pipe which is manufactured by joining side surfaces of the ribbon heater according to a first embodiment of the present invention, using a butt joint method.

In the case of the method of manufacturing the anti-freezing pipe according to the first embodiment of this invention, the ribbon heater 10 which is shown in FIGS. 1 and 2 is wound in a spiral form, and a junction portion 22 is joined or welded between side surfaces of the ribbon heater 10, using a butt joint method, so as to have a cylindrical shape, as shown in FIGS. 3 and 4.

As shown in FIG. 3, in the case of the anti-freezing pipe 20a which is obtained according to the first embodiment of this invention, both electric power terminals 7a and 7b are disposed at one side of the anti-freezing pipe 20a. As shown in FIG. 5, the anti-freezing pipe 20a has a pattern of a surface heating element 1 at the other side 11 of which the electric power terminals 7a and 7b are connected with each other. Otherwise, as shown in FIG. 4, both electric power terminals 7a and 7b may be disposed at one side and the other side of an anti-freezing pipe 20b, respectively.

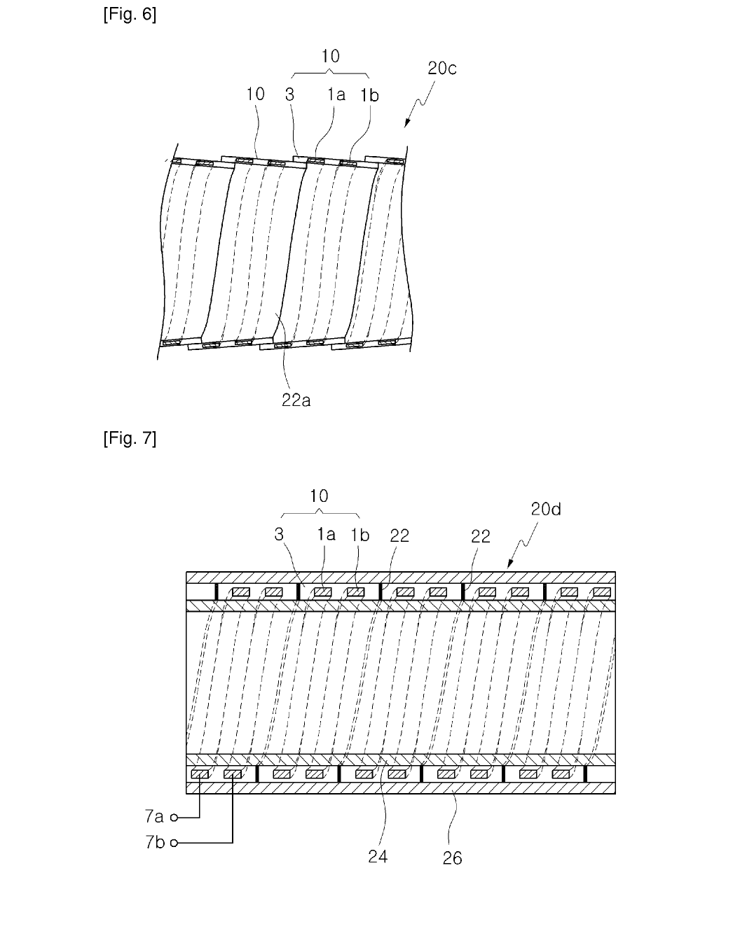

In addition, as shown in FIG. 6, in the case of the method of manufacturing an anti-freezing pipe 20c according to a second embodiment of this invention, the side surfaces of the spirally wound ribbon heater 10 overlap by a predetermined width over each other and the overlapping junction portions 22a are joined or welded so as to form a cylindrical shape by an overlap joint method.

FIG. 7 is a cross-sectional view lengthily illustrating the anti-freezing pipe which is manufactured by winding the ribbon heater according to a third embodiment of the present invention on the outer circumference of a previously fabricated pipe and then forming a protective layer by an insert-extrusion method.

As shown in FIG. 7, in the case of the anti-freezing pipe 20d according to the third embodiment of the present invention, a ribbon heater 10 is wound on the outer circumference of a previously fabricated pipe 24 and then a protective layer 26 is formed by an insert-extrusion method. Any kinds of the synthetic resin which can be insert-extruded and has an insulation property and a heat resistant property can be used as the protective layer 26.

In the embodiment shown in FIG. 7, the ribbon heater 10 may be wound on the outer circumference of the pipe 24 by a butt joint method or by an overlap joint method, and then the protective layer 26 may be insert-extruded on the outer circumference of the ribbon heater 10. In addition, since the ribbon heater 10 is wound on the outer circumference of the pipe 24 and then the protective layer 26 is formed on the outer circumference of the ribbon heater 10, in the case of the anti-freezing pipe 20d according to the third embodiment of the present invention, the ribbon heater 10 may be wound at a predetermined interval.

In the embodiment illustrated in FIG. 7, the protective layer 26 can make it possible to omit a weld of the wound ribbon heater 10 to the junction portion 22, and plays a role of preventing heat generated from the ribbon heater 10 from being emitted to the outside, in addition to protection of the ribbon heater 10.

The anti-freezing pipe 20d according to the third embodiment of the present invention can be inexpensively inserted on the outer circumference of a pre-fabricated general synthetic resin or metallic pipe 24, and contains the ribbon heater 10 formed of a thin film. Accordingly, no problems occur in order to endure an internal pressure of fluid in the pipe. As a result, it is possible to form a thin film protective layer 26.

As described above, since the anti-freezing pipes according to the first to third embodiments of the present invention contain the ribbon heater 10 in the inside of the pipes, there is no need to wind a separate anti-freezing heater on the outer circumference of the pipe. Accordingly, a piping work may be easily performed.

In addition, in the case of the anti-freezing pipe according to this invention, the first and second electric power terminals 7a and 7b are connected to both ends of the strip type surface heating element 1 and an alternating-current (AC) or direct-current (DC) electric power source is connected between the first and second electric power terminals 7a and 7b. Accordingly, the strip type surface heating element 1 in the ribbon heater 10 is heated in the range of 30-50° C., to thus prevent the pipe from being frozen to burst.

In this case, the ribbon heater 10 which is applied in this invention is embodied into a thin film form using the surface heating element 1 made of a strip form as indicated as 1a and 1b in FIG. 7, in which the low temperature surface heating element 1 whose thermal density is low is used. As a result, a thin film insulation layer 3 is coated on the surface heating element 1, to resultantly form a thin film heater 10 whose thickness is generally thin. Thus, the surface heating element 1 widens a contact area where the heater contacts fluid in the pipe, and heat is transferred through the thin film insulation layer 3, to thereby heighten a heat transfer efficiency of the heater and reduce electric power consumption thereof.

In addition, the pipe having an anti-freezing function according to the present invention uses a material which can be inexpensively fabricated by a sequential production method by using an inexpensive metallic material such as Fe instead of using an expensive metallic material such as Ni, as the heater 1. In particular, a Fe-based amorphous alloy material is used as the ribbon heater 1 so as to be inexpensively fabricated by a sequential production method, to thus have high cost-competitive power.

In the embodiments which have been described above, the ribbon heater is fabricated by using the surface heating element having a structure where two or one strip is connected in series. However, a number of strips may be used as a pattern of a series connection form. Further, in the case that the overall length of the heater is prolonged, it is possible to form a surface heating element by using a number of strips which are connected in parallel with each other or in a combination of series and parallel connections.

### MODE FOR THE INVENTION

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, the present invention may be applied to an anti-freezing pipe in which a ribbon heater using a strip type surface heating element is buried to supply heat necessary for preventing the pipe from being frozen to burst, to thereby prevent the pipe through which fluid is transferred from being frozen to burst although temperature of atmosphere is fallen in winter season.

1. A pipe having an anti-freezing function, the anti-freezing pipe comprising: a ribbon heater which has a strip type surface heating element which emits heat when electric power is applied to both ends of at least one strip, and the strips are arranged with an interval in parallel with each other when the strip type surface heating element is formed with a number of strips, and an insulation layer which is coated on the outer circumference of the strip type surface heating element in a plate form, and which is spirally wound to form a cylindrical shape; and a spiral junction portion which joins side surfaces of the spirally wound ribbon heater.

2. The anti-freezing pipe according to claim 1, wherein the junction portion is formed by a butt joint method at a state where the side surfaces of the ribbon heater face each other.

3. The anti-freezing pipe according to claim 1, wherein the junction portion is formed by an overlap joint method at a state where the side surfaces of the spirally wound ribbon heater overlap each other.

4. The anti-freezing pipe according to claim 1, wherein the strip type surface heating element is made of an amorphous strip or FeCrAl.

5. The anti-freezing pipe according to claim 1, wherein the amorphous strip is made of a Fe-based alloy material.

6. The anti-freezing pipe according to claim 1, wherein the amorphous strip is made into 10-50 μm thick

7. The anti-freezing pipe according to claim 1, wherein the strips are joined by any one of a series connection, a parallel connection and a combination of series and parallel connections.

8. The anti-freezing pipe according to claim 1, wherein an electric current interruption unit which operates within a predetermined range of temperature is further installed on the strip.

9. The anti-freezing pipe according to claim 1, wherein the strips are processed into a number of waves so as to absorb pressures of the fluid flowing in the pipe.

10. A pipe having an anti-freezing function, the anti-freezing pipe comprising:
a cylindrical pipe;
a ribbon heater which has a strip type surface heating element which emits heat when electric power is applied to both ends of at least one strip, and the strips are arranged with an interval in parallel with each other when the strip type surface heating element is formed with a number of strips, and an insulation layer which is coated on the outer circumference of the strip type surface heating element in a plate form, and which is spirally wound to form a cylindrical shape; and
a protective layer which is formed on the outer side of the ribbon heater to protect the spirally wound ribbon heater.

11. The anti-freezing pipe according to claim 10, wherein the ribbon heater which is spirally wound on the outer circumference of the pipe is wound in a butt joint form or an overlap joint form between the side surfaces of the spirally wound ribbon heater.

12. The anti-freezing pipe according to claim 10, wherein the strip type surface heating element is made of an amorphous strip or FeCrAl.

13. The anti-freezing pipe according to claim 12, wherein the amorphous strip is made of a Fe-based alloy material.

14. The anti-freezing pipe according to claim 10, wherein the strips are joined by any one of a series connection, a parallel connection and a combination of series and parallel connections.

15. A method of manufacturing a pipe having an anti-freezing function, the anti-freezing pipe manufacturing method comprising the steps of:
overlapping an insulation film on the respective upper and lower sides of a strip type surface heating element which emits heat when electric power is applied to both ends of at least one strip, and the strips are arranged with an interval in parallel with each other when the strip type surface heating element is formed with a number of strips, to thereby fabricate a ribbon heater in which an insulation layer is formed on the outer circumference of the strip type surface heating element in a plate shape; and
winding the ribbon heater spirally so as to form a cylindrical shape to simultaneously join the side surfaces of the spirally wound ribbon heater.

16. The anti-freezing pipe manufacturing method according to claim 15, wherein a butt joint method is employed at a state where the side surfaces of the ribbon heater face each other, or an overlap joint method is employed at a state where the side surfaces of the spirally wound ribbon heater overlap each other, in order to join the side surfaces of the ribbon heater.

17. The anti-freezing pipe manufacturing method according to claim 15, wherein the strip type surface heating element is made of an amorphous strip or FeCrAl.

18. A method of manufacturing a pipe having an anti-freezing function, the anti-freezing pipe manufacturing method comprising the steps of:
overlapping an insulation film on the respective upper and lower sides of a strip type surface heating element which emits heat when electric power is applied to both ends of at least one strip, and the strips are arranged with an interval in parallel with each other when the strip type surface heating element is formed with a number of strips, to thereby fabricate a ribbon heater in which an insulation layer is formed on the outer circumference of the strip type surface heating element in a plate shape; and
winding the ribbon heater spirally on the outer circumference of the pipe to simultaneously insert-extrude a protective layer on the outer side of the ribbon heater to protect the spirally wound ribbon heater.

19. The anti-freezing pipe manufacturing method according to claim 18, wherein the ribbon heater which is spirally wound on the outer circumference of the pipe is wound in a butt joint form or an overlap joint form between the side surfaces of the spirally wound ribbon heater.

20. The anti-freezing pipe manufacturing method according to claim 18, wherein the strip type surface heating element is made of an amorphous strip or FeCrAl.
